(19) United States
(12) Patent Application Publication
(10) Pub. No.: US 2010/0283329 A1
(43) Pub. Date: Nov. 11, 2010

(54) GREEN CONSENT

(76) Inventor: Gang-Deok Bak, Incheon City (KR)

Correspondence Address: JENKINS, WILSON, TAYLOR & HUNT, P. A., 3100 Tower Blvd., Suite 1200, DURHAM, NC, 27707, US

(21) Appl. No.: 12/279,787

(22) PCT Filed: Feb. 22, 2007
(86) PCT No.: PCT/KR2007/000926

§ 371 Date: Jun. 22, 2010

(30) Foreign Application Priority Data
Feb. 24, 2006 (KR) 10-2006-0018377

(51) Int. Cl. H02J 1/00

(52) U.S. Cl. 307/125

(57) ABSTRACT

Provided is normal and system-type green consents. The green consent includes an external power source; a lightning prevention circuit; a first power supply unit; a second power supply unit; a current sensing unit; a control unit for receiving a current detection signal from the current sensing unit and outputting a control signal to an LED and a buzzer, and for receiving a control signal from a home server or a main controller via a ZigBee module and a control signal from a remote control or a mobile phone via an irDA sensor to block the voltage from the external power source; a power controller; the irDA sensor; an infrared operation-monitoring sensor; a ZigBee module; a mode select switch; a reset switch; an RS485 unit for converting and transmitting/receiving a signal so that the green consent is externally controlled, by communicating with the control unit via a cable; and an outlet having holes respectively connected to one line extending from the external power source and the other line extending from the power controller, the external load being plugged in the outlet.

### TECHNICAL FIELD

The present invention relates to normal and system-type green consents, and more particularly, to a green consent comprising an external power source for supplying the power voltage to the external load via power lines, the power voltage having an inverse wavelength of two natures of H and N; a lightning prevention circuit disposed between the two power lines of the external power source for protecting the external load from lightning; a first power supply unit connected to the external power source for dropping the voltage supplied from the external power source to a 12V voltage; a second power supply unit for dropping the output voltage of the first power supply unit to a 5V voltage; a current sensing unit for measuring the intensity of a current from the external power source; a control unit for receiving a current detection signal from the current sensing unit and outputting a control signal to an LED and a buzzer, and for receiving a control signal from a home server or a main controller via a ZigBee module and a control signal from a remote control or a mobile phone via an irDA sensor to block the voltage from the external power source; a power controller for blocking the power voltage in response to the control signal from the control unit; the irDA sensor for transmitting a reset control signal to the control unit through infrared communication; an infrared operation-monitoring sensor for transmitting the reset control signal to the irDA sensor through the infrared communication; a ZigBee module for enabling the green consent to be externally controlled, by wirelessly communicating with the control unit; a mode select switch for selecting one of modes of the control unit; a reset switch for reactivating the supply of the power source blocked by the control unit; an RS485 unit for converting and transmitting/receiving a signal so that the green consent is externally controlled, by communicating with the control unit via a cable; and an outlet having holes respectively connected to one line extending from the external power source and the other line extending from the power controller, the external load being plugged in the outlet.

### BACKGROUND ART

In general, an outlet collectively refers to units connected to an indoor electricity supply wiring for supplying electricity to a load via a plug of the load inserted into the outlet. The outlet is used as an intermediate medium for supplying electricity at a regular voltage of 100V and 220V and a regular current of 10 to 50A from an external power source to various consumer electronics.

Outlets are greatly classified into a buried outlet and an exposed outlet. In particular, the buried outlet relating to the present invention comprises a terminal board connected to an external power line, a plug guide plate attached to a front of the terminal board, and a protecting cover for covering the terminal board and the plug guide plate.

The conventional buried outlet described above is attached to an indoor wall and is always ready to supply a power voltage to consumer electronics. When a user does not inadvertently pull a plug out of the outlet after he or she inserts the plug into the outlet to use a consumer electronics, the power leaks through the plug left inserted, causing energy waste and economical loss.

Furthermore, overcurrent or lightning may be induced and malfunction of consumer electronics or firing may occur.

### DISCLOSURE OF INVENTION

### Technical Problem

It is an object of the present invention to provide normal and system-type green consents capable of protecting external loads from overcurrent-induced firing and lightning and preventing consumption of standby power when the external loads are not in use, by using a lightning prevention circuit, a current sensing unit, and a power controller.

It is another object of the present invention to provide normal and system-type green consents that can be controlled by a remote control, a home server, or a mobile phone or the Internet outside a building by connecting a communication unit including irDA, ZigBee and RS485 modules to a control unit.

### Technical Solution

According to an aspect of the present invention, there is provided a green consent buried in a wall of a building for supplying a power voltage to an external load, and the outlet comprises: an external power source for supplying the power voltage to the external load via power lines, the power voltage having an inverse wavelength of two natures of H and N; a lightning prevention circuit disposed between the two power lines of the external power source for protecting the external load from lightning; a first power supply unit connected to the external power source for dropping the voltage supplied from the external power source to a 12V voltage; a second power supply unit for dropping the output voltage of the first power supply unit to a 5V voltage; a current sensing unit for measuring the intensity of a current from the external power source; a control unit for receiving a current detection signal from the current sensing unit and outputting a control signal to an LED and a buzzer, and for receiving a control signal from a home server or a main controller via a ZigBee module and a control signal from a remote control or a mobile phone via an irDA sensor to block the voltage from the external power source; a power controller for blocking the power voltage in response to the control signal from the control unit; the irDA sensor for transmitting a reset control signal to the control unit through infrared communication; an infrared operation-monitoring sensor for transmitting the reset control signal to the irDA sensor through the infrared communication; a ZigBee module for enabling the green consent to be externally controlled, by wirelessly communicating with the control unit; a mode select switch for selecting one of modes of the control unit; a reset switch for re-activating the supply of the power source blocked by the control unit; an RS485 unit for converting and transmitting/receiving a signal so that the green consent is externally controlled, by communicating with the control unit via a cable; and an outlet having holes respectively connected to one line extending from the external power source and the other line extending from the power controller, the external load being plugged in the outlet.

### ADVANTAGEOUS EFFECTS

As described above, using the lightning prevention circuit, the current sensing unit, and the power controller, external loads can be protected from overcurrent-induced firing and lightning, and consumption of standby power can be prevented when the external loads are not in use.

With the communication unit including the irDA, ZigBee and RS485 modules connected to the control unit, the green consents can be controlled using a remote control, a home server, or a mobile phone or the Internet outside a building.

### BRIEF DESCRIPTION OF THE DRAWINGS

FIG. 1 is a front and side view of an outlet with one port;

FIG. 2 is a front and side view of an outlet with two ports;

FIG. 3 is a block diagram illustrating a green consent without a communication unit; and

FIG. 4 is a block diagram illustrating a green consent with a communication unit.

### EXPLANATION ON ESSENTIAL ELEMENTS OF DRAWINGS

10: control unit 15: current sensing unit

20: power controller 25: lightning prevention circuit

30: first power supply unit 35: second power supply unit

40: First outlet, Second outlet 45: external power source

50: mode select switch 55: reset switch

60: LED 65: buzzer

70: irDA sensor 75: infrared operation-monitoring sensor

130: ZigBee modul 150: RS485 unit

### MODE FOR THE INVENTION

Hereinafter, embodiments of the present invention will be described in detail.

However, the present invention is not limited to the embodiments disclosed below, but can be implemented in various types. Therefore, the present embodiments are provided for complete disclosure of the present invention and to fully inform the scope of the present invention to those ordinarily skilled in the art.

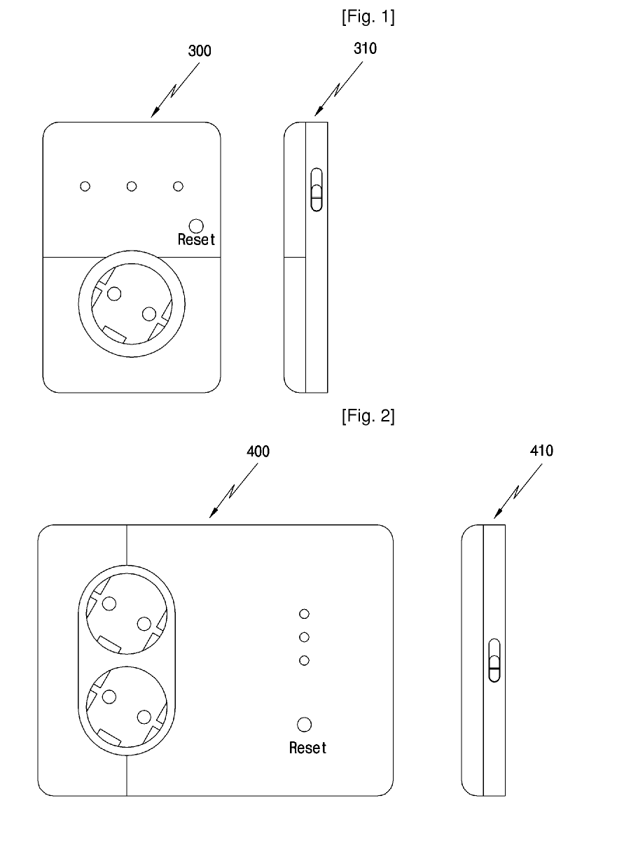

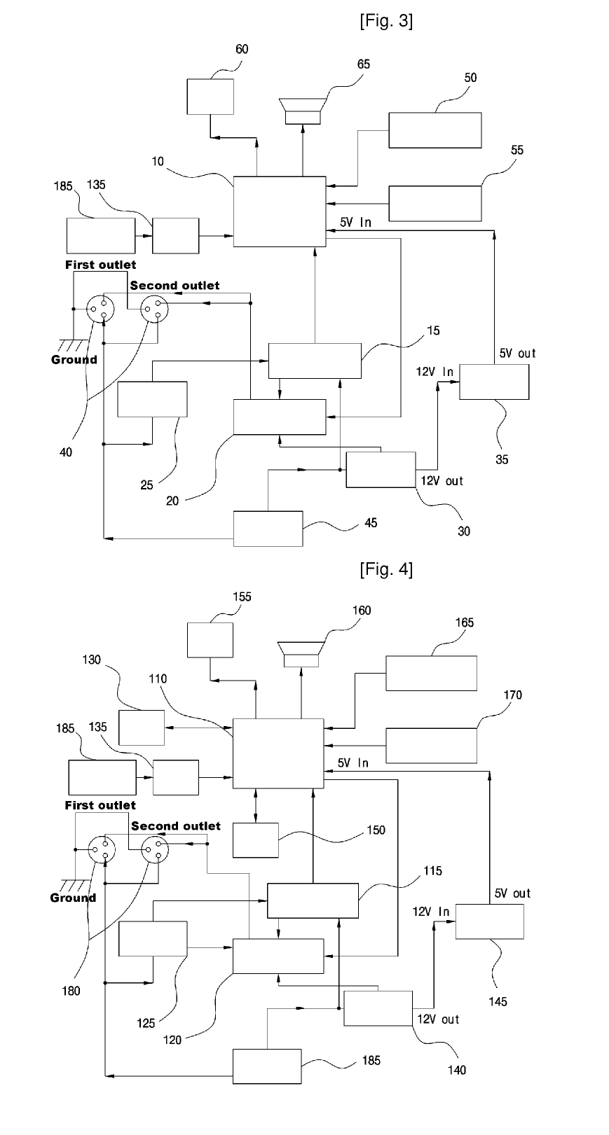

FIG. 1 is a front and side view of an outlet with one port, FIG. 2 is a front and side view of an outlet with two ports, FIG. 3 is a block diagram illustrating a green consent without a communication unit, and FIG. 4 is a block diagram illustrating a green consent with a communication unit.

FIG. 3 illustrates a green consent without a communication unit according to a first embodiment of the present invention.

Referring to FIG. 3, the green consent comprises an external power source 45 connected to an inside of the building via different power lines for supplying a power voltage to an external load. The power voltage has an inverse wavelength of two natures of H and N. The green consent comprises a lightning prevention circuit 25 connected between the two lines of the external power source 45 for preventing a short circuit of the two lines. The lightning prevention circuit 25 is charged with electricity, like a condenser, when lightning is input along the two power lines connected with the external power source 45, and then the charged electricity is slowly discharged so that an external load is protected from the lightning. The green consent further comprises a first power supply unit 30 and a second power supply unit 35. The first power supply unit 30 drops a high voltage from the external power source 45 to a 12V voltage for a power controller 20. The second power supply unit 35 drops the output voltage of the first power supply unit 30 to a 5V voltage for a control unit 10, a current sensing unit 15, and a ZigBee module 130.

Meanwhile, among the two lines of the external power source 45, one is connected to one terminal of the outlet 40 and the other line is connected to an IP+ terminal of the current sensing unit 15. An IP− terminal of the current sensing unit 15 is connected to the power controller 20.

The current sensing unit 15 measures current from the external power source 45 and sends a current measurement value to the control unit 10. The control unit 10 sends an alarm and a control signal to block the power voltage to the controller 20 when the current measurement value is higher than a predetermined value. The control unit 10 sends the control signal to the power controller 20 to block the power voltage when the current measurement value is lower than a predetermined value for a predetermined time.

The green consent further comprises an irDA sensor 70 connected to the control unit 10. The irDA sensor 70 receives a reset control signal from an irDA sensor in a remote control or a mobile phone or a reset control signal from an infrared operation-monitoring sensor 75 that monitors the operation, and sends the reset control signal to the control unit 10.

The power controllers 20 is connected to the other terminal of the outlet 40 via a relay switch (not shown) for transmitting the electricity passing through the current sensing unit 15. In response to the control signal from the control unit, the power controller 20 controls the relay switch to block the power voltage.

The green consent further comprises a reset switch 55 connected to the control unit 10. The reset switch 55 allows a user to activate the supply of the power voltage after the user addresses causes of power shutdown when the power supply is blocked due to overcurrent, standby current, lightning, and the like. The green consent further comprises a mode select switch 50 connected to the control unit 10 for selecting a manual mode in which a user directly blocks the power voltage or activates the supply of the power voltage, and an automatic mode in which the control unit 10 automatically controls the outlet.

FIG. 4 is a block diagram illustrating a system-type green consent capable of wired and wireless communication according to a second embodiment of the present invention.

Referring to FIG. 4, the green consent comprises an external power source 180, a control unit 110, a current sensing unit 115, a power controller 120, a mode select switch 165, and a reset switch 170, which are the same as those shown in FIG. 3. The green consent further comprises a communication module connected to the control unit 110 for enabling a user at an outdoor location to control the outlet 80 or outlets at other places.

The communication module may include a ZigBee module 130, an irDA sensor 135, and an RS485 unit 150. The ZigBee module 130 receives a control signal from a home server located inside the building and sends the control signal to the control unit 110. The ZigBee module 130 allows the user outside the building to connect to the home server using a mobile phone or the Internet and control the outlet 80. The ZigBee module 130 sends a current state of the outlet 80 to the home server. When the power voltage is blocked due to overcurrent, standby current, or lightning, the irDA sensor 135 enables the user who is under a state that cannot press the reset switch 170 to activate the outlet 80 using the remote control or mobile phone with an irDA sensor. The RS485 unit 150 is connected to the home server via a cable and allows the user in the building to control the outlet 80 using the mobile phone or the Internet.

The green consent without the communication unit and the green consent with the communication unit may be manufactured with the required number of ports, to which external loads will be connected.

In the first embodiment, the outlet with one port has the front 300 and the side 310 as shown in FIG. 1, and in the second embodiment, the outlet with two ports has the front 400 and side 410 as shown in FIG. 2.

The configurations of the two green consents are the same except the communication module.

The configurations will now be described in greater detail.

The outlet of the present invention comprises the control device for preventing consumption of standby power and protecting the external loads from firing incurred by lightning or overcurrent due to presence of lots of external loads when the two power lines for the external power source 45 or 180 are connected to the outlet 40 or 80 and the external loads are plugged in the outlet.

First, when lightning is input through two power lines for the external power source 45 or 180, the lightning prevention circuit 25 or 125 connected between the two power lines absorbs high-voltage electricity from the lightning and slowly discharges the electricity, so that the external loads are protected from the lightning. Among the two power lines for the external power source, one line is directly connected to a connection hole of the outlet 40 or 80 and the other line is connected to the current sensing unit 15 or 115. The current sensing unit 15 or 115 measures the current and sends the current measurement value to the control unit 10 or 110. The electricity passing through the current sensing unit 15 or 115 is sent to the power controller 20 or 120.

Here, the power controller 20 or 120 comprises the relay switch activated by induced electricity, and an induced electricity transmitting unit for transmitting the induced electricity. The induced electricity transmitting unit operates at a 12V voltage. As the control unit 10 or 110 outputs a signal when overcurrent, standby current, or lightning flows, the induced electricity flows and the relay switch is turned off, such that the power voltage is blocked.

Meanwhile, the control unit 10 or 110 comprises a microprocessor, which is connected with the mode select switch 50 or 165; the reset switch 55 or 170; the communication modules such as the ZigBee module 130, the irDA sensor 70 or 135, and the RS485 unit 150; the display device such as the LED 60 or 155; and the buzzer 65 or 160. The control unit outputs the control signal to the power controller 20 or 120 and receives the measurement value from the current sensing unit 15 or 115.

Here, the communication module can be selectively used according to its several functions. First, the ZigBee module 130 wirelessly receives an external control signal, i.e., a block signal or a connection signal from the home server or the main controller and sends it to the control unit 10 or 110. The ZigBee module 130 receives a state signal, i.e., a block or connection state signal from the control unit 10 or 110 and sends it to the home server so that the user controls the outlet.

When the outlet 40 or 80 is located beyond user s reach or at a remote place, the user operates the remote control or mobile phone having the irDA sensor therein to output the reset control signal for reactivation, and the irDA sensor 70 or 135 receives the reset control signal and sends it to the control unit 10 or 110. The RS485 unit 150 receives an external control signal, i.e., a block or connection signal from the home server via the cable. The RS485 unit 150 communicates with the control unit 10 or 110 so that the user in the building checks or controls the outlet 40 or 80.

Furthermore, the infrared operation-monitoring sensor enables the user who does not carry a remote control or a mobile phone to activate the outlet by sensing the operation and sending the reset control signal to the irDA sensor 70 or 135 to reactivate the supply of the power voltage.

While the invention has been shown and described with reference to certain exemplary embodiments thereof, it will be understood by those skilled in the art that various changes in form and details may be made therein without departing from the spirit and scope of the invention as defined by the appended claims.

1. A green consent buried in a wall of a building for supplying a power voltage to an external load, the outlet comprising:
an external power source 180 for supplying the power voltage to the external load via power lines, the power voltage having an inverse wavelength of two natures of H and N;
a lightning prevention circuit 125 disposed between the two power lines of the external power source 180 for protecting the external load from lightning;
a first power supply unit 140 connected to the external power source 180 for dropping the voltage supplied from the external power source 180 to a 12V voltage;
a second power supply unit 145 for dropping the output voltage of the first power supply unit 140 to a 5V voltage;
a current sensing unit 115 for measuring the intensity of a current from the external power source 180;
a control unit 110 for receiving a current detection signal from the current sensing unit 115 and outputting a control signal to an LED 155 and a buzzer 160, and for receiving a control signal from a home server or a main controller via a ZigBee module 130 or a control signal from a remote control or a mobile phone via an irDA sensor 135 to block the voltage from the external power source 180;
a power controller 120 for blocking the power voltage in response to the control signal from the control unit 110;
the irDA sensor 135 for transmitting a reset control signal to the control unit 110 through infrared communication;
an infrared operation-monitoring sensor 185 for transmitting the reset control signal to the irDA sensor 135 through the infrared communication;
a ZigBee module 130 for enabling the green consent to be externally controlled, by wirelessly communicating with the control unit 110;
a mode select switch 165 for selecting one of modes of the control unit 110;
a reset switch 170 for reactivating the supply of the power source blocked by the control unit 110;
an RS485 unit 150 for converting and transmitting/receiving a signal so that the green consent is externally controlled, by communicating with the control unit 110 via a cable; and
an outlet 80 having holes respectively connected to one line extending from the external power source 180 and the other line extending from the power controller, the external load being plugged in the outlet 80.

2. A green consent buried in a wall of a building for supplying a power voltage to an external load, the outlet comprising:
an external power source 45 for supplying the power voltage to the external load via power lines, the power voltage having an inverse wavelength of two natures of H and N;
a lightning prevention circuit 25 disposed between the two power lines of the external power source 45 for protecting the external load from lightning;
a first power supply unit 30 connected to the external power source 45 for dropping the voltage supplied from the external power source 45 to a 12V voltage;
a second power supply unit 35 for dropping the output voltage of the first power supply unit 30 to a 5V voltage;
a current sensing unit 15 for measuring the intensity of a current from the external power source 45;
a control unit 10 for receiving a current detection signal from the current sensing unit 15 and outputting a control signal to an LED 60 and a buzzer 65, and for receiving a control signal from a remote control or a mobile phone via an irDA sensor 70 to block the voltage from the external power source 45;
a power controller 20 for blocking the power voltage in response to the control signal from the control unit 10;
the irDA sensor 70 for transmitting a reset control signal to the control unit 10 through infrared communication;
an infrared operation-monitoring sensor 75 for transmitting the reset control signal to the irDA sensor 70 through the infrared communication;
a mode select switch 50 for selecting one of modes of the control unit 10;
a reset switch 55 for reactivating the supply of the power source blocked by the control unit 10; and
an outlet 40 having holes respectively connected to one line extending from the external power source 45 and the other line extending from the power controller 20, the external load being plugged in the outlet 40.

3. The green consent according to claim 1 or 2, wherein the current sensing unit 15 or 115 measures the current from external power source and sends a measurement value to the control unit 10 or 110, and the external power voltage passing through the current sensing unit 15 or 115 is output to the power controller 20 or 120.

4. The outlet according to claim 1 or 2, wherein the power controller 20 or 120 blocks the flow of the power voltage from the external power source using a relay switch in response to a signal output from the control unit 10 or 110, the control unit 10 or 110 outputting the signal when a current measurement value received from the current sensing unit 15 or 115 indicates overcurrent or standby current.

5. the outlet according to claim 1 or 2, wherein the control unit 10 or 110 blocks the power voltage from the external power source when the current measurement value from the current sensing unit 15 or 115 indicates overcurrent and standby current, and outputs a signal indicating a current state to the LED 60 or 155 and the buzzer 65 or 160 connected to the control unit.

6. The outlet according to claim 1 or 2, wherein the mode select switch 50 or 165 connected with the control unit 10 or 110 is capable of switching the operation of the control unit automatically or manually, and the reset switch 55 or 170 connected with the control unit 10 or 110 resets the control unit 10 or 110 so that the outlet is reactivated after causes of power shutdown are eliminated.

7. The outlet according to claim 1 or 2, wherein the irDA sensor 70 or 135 sends the reset control signal to the control unit 10 or 110 in response to a signal from an irDA sensor in a remote control or a mobile phone.

8. The outlet according to claim 1 or 2, wherein the infrared operation-monitoring sensor 75 or 185 senses an external motion to send a reset control signal to the irDA sensor.

9. The outlet according to claim 1, wherein the control unit 110 communicates with the ZigBee module 130, the irDA sensor 135, and the RS485 unit 150 to send a control signal to the power controller 120 to block or connect the power voltage, and transmits current state information to the home server or the main controller via the ZigBee module 130 or the RS485 unit 150.

10. The outlet according to claim 1, wherein the ZigBee module 130 wirelessly communicates with a home server disposed at any indoor place, receives a control command from a user at the home server to send it to the control unit 110, and transmits a signal from the control unit 110 to the home server.
